(19) United States
(12) Patent Application Publication
(10) Pub. No.: US 2015/0376493 A1
(43) Pub. Date: Dec. 31, 2015

(54) Hydrophobic Paramagnetic Nanoparticles as Intelligent Crude Oil Tracers

(71) Applicant: BOARD OF REGENTS, THE UNIVERSITY OF TEXAS SYSTEM, Austin, TX (US)

(72) Inventors: Chun Huh, Austin, TX (US); Nabijan Nizamidin, Austin, TX (US); Gary A. Pope, Cedar Park, TX (US); Thomas E. Milner, Austin, TX (US); Bingqing Wang, Austin, TX (US)

(21) Appl. No.: 14/765,426

(22) PCT Filed: Jan. 15, 2014
(86) PCT No.: PCT/US2014/011654

§ 371 Date: Aug. 3, 2015

Related U.S. Application Data
(60) Provisional application No. 61/760,743, filed on Feb. 5, 2013.

(51) Int. Cl. C09K 8/58; G01V 3/26; C09K 8/80; E21B 43/16; E21B 47/00

(52) U.S. Cl. CPC C09K 8/58; E21B 43/16; E21B 47/00; C09K 8/805; G01V 3/26

(57) ABSTRACT

Hydrophobic paramagnetic nanoparticles can be injected with the enhanced oil recovery injection water by incorporating them inside of surfactant micelles to serve as an oil tracer. A variety of paramagnetic nanoparticles that show different susceptibility and magnetization responses to applied magnetic oscillation can be injected at different injectors, so that the origin of the oil from the different enhanced oil recovery patterns could be quantitatively identified. The concentrations of the nanoparticles in the produced crude oil and brine can be easily and instantly measured individually, employing the magnetic susceptibility meter without contacting the fluids directly.

### TECHNICAL FIELD OF THE INVENTION

The present invention relates generally to methods and compositions used in tracking the movement of fluids in subsurface formations using magnetic nanoparticles.

### BACKGROUND ART

Without limiting the scope of the invention, its background is described in connection with methods for magnetic imaging of geological structures and more specifically to nanomaterial-containing signaling compositions used to assay a liquid in geological formations.

During oil and gas production a portion of the hydrocarbon stores are retained in the geological structures, although various mechanisms are used to remove these stores and increase production. This retained portion is known as the residual oil saturation, which is oil saturation that cannot be produced from an oil reservoir from gas or water displacement. The oil saturation is the fraction of the pore space occupied by oil. Knowing the oil saturation still left in the reservoir during the oil production is important for optimal management of the oil reservoir. In particular, knowing the residual oil saturation in the mature oil reservoir is the key requisite for the design and implementation of enhanced oil recovery methods.

With the methods currently used for oil saturation determination, such as the Nuclear Magnetic Resonance (NMR) logging and the injection of partitioning tracers, it is difficult to obtain reliable information for a large volume of the reservoir. For example, the probing depth of NMR logging is very shallow, i.e., in centimeters. With the analysis of the effluent profile of the partitioning tracers produced at the production wells, only the average oil saturation in the oil reservoir could usually be determined.

U.S. Pat. No. 8,269,501, entitled, “Methods for Magnetic Imaging of Geological Structures,” discloses methods for imaging geological structures include injecting magnetic materials into the geological structures, placing at least one magnetic probe in a proximity to the geological structures, generating a magnetic field in the geological structures and detecting a magnetic signal. The at least one magnetic probe may be on the surface of the geological structures or reside within the geological structures. The methods also include injecting magnetic materials into the geological structures, placing at least one magnetic detector in the geological structures and measuring a resonant frequency in the at least one magnetic detector. Methods for using magnetic materials in dipole-dipole, dipole-loop, and loop-loop transmitter-receiver configurations for geological structure electromagnetic imaging techniques are also disclosed.

U.S. Pat. No. 8,323,618, entitled, “Ultrasmall Superparamagnetic Iron Oxide Nanoparticles and Uses Thereof,” discloses biomimetic contrast agents, dual functional contrast agents effective for therapeutic gene delivery and magnetic nanoparticles which comprise functionalized iron oxide nanoparticle cores, one of an inert gold layer, a layer of inert metal seeds or a silica layer and, optionally, one or both of an outer gold-silver nanoshell or a targeting ligand attached to the inert gold layer or the gold-silver nanoshell. Also provided are methods of in vivo magnetic resonance imaging, of treating primary or metastatic cancers or of ablating atherosclerotic plaque using the contrast agents and magnetic particles. In addition, kits comprising the biomimetic contrast agents, dual contrast agents, and magnetic nanoparticles.

U.S. Patent Application Publication No. 2012/0142111, entitled, “Nanomaterial-Containing Signaling Compositions for Assay of Flowing Liquid Streams and Geological Formations and Methods for use Thereof,” discloses compositions containing a transporter component and a signaling component and a method for using said compositions for analyzing porous media and flowing liquid streams, specifically for measuring pressure, temperature, relative abundance of water, pH, redox potential and electrolyte concentration. Analytes may include petroleum or other hydrophobic media, sulfur-containing compounds. The transporter component includes an amphiphilic nanomaterial and a plurality of solubilizing groups covalently bonded to the transporter component. The signaling component includes a plurality of reporter molecules associated with the transporter component. The reporter molecules may be releasable from the transporter component upon exposure to at least one analyte. The reporter molecules may be non-covalently associated with the transporter component, or the reporter molecules are covalently bonded to the transporter component. Furthermore, said compositions and methods may be used to actively enhance oil recovery and for remediation of pollutants.

### DISCLOSURE OF THE INVENTION

When an improved oil recovery (IOR) process is implemented at an oil reservoir, the ability to assess the process performance at a very early stage of operation can greatly help the optimal management of the process. The present inventors realized that before and immediately after the implementation of an IOR process (e.g., waterflooding) if the spatial distribution of oil in the reservoir could be accurately determined, it will have an enormous impact on the optimal reservoir management. The present inventors developed a novel way of using hydrophobically surface-treated paramagnetic nanoparticles as an intelligent oil tracer. Additionally, the nanoparticles of the present invention can pick up some finger-printing components from the reservoir oil, which can be analyzed from the produced fluids.

During the multiple-pattern implementation of IOR processes, it is difficult to distinguish the source of the oil produced at a production well, i.e., what portion of the produced oil is mobilized by the IOR fluid injected at which injection well. A quantitative identification of the origin of the produced oil will greatly help the process optimization. The proposed method can solve the problem. Additionally, if the oil from a particular flood pattern requires a special attention, e.g., shows a sign of bacterial souring, such characteristics of the oil from a specific pattern could be determined by the method.

Hydrophobic paramagnetic nanoparticles, which serve as an oil tracer, can be injected with the IOR injection water by incorporating them inside of surfactant micelles. The overall concentration of the nanoparticles in the produced crude oil and brine can be easily measured, employing the magnetic susceptibility meter which is available readily. The individual concentrations of the different types of nanoparticles injected at the different injection wells can be determined by employing the magnetization response measurements and the newly developed inversion technique by this invention. The measurements can be made without contacting the fluids directly, as long as the flow-line material is magnetically transparent. A variety of paramagnetic nanoparticles that show different magnetization response at different magnetic field application can be injected at different injectors, so that the origin of the oil from the different IOR patterns could be quantitatively identified. With application of prescribed surface coating to a particular kind of nanoparticle, certain finger-printing components of oil could also be picked-up; the nanoparticles that carry the fingerprinting components can be collected by the High Gradient Magnetic Separation (HGMS) method from the produced oil and the concentration of the finger-printing components can be analyzed.

The present invention provides a method of analyzing the movement of the injected fluid bank in a subterranean formation by adding one or more different kinds of magnetic nanoparticles in the injected fluid; transferring the magnetic nanoparticles to the hydrocarbon phase that is being produced; and placing at least one magnetic probe in a proximity to the nanoparticle-containing fluids that are being produced; generating a magnetic field and detecting the magnetization response with the at least one magnetic probe; and thereby generating data relating to the movement of the injected fluid bank in the subterranean formation. In addition, the one or more magnetic nanoparticles may include a coating to ensure a long-term dispersion stability and to avoid adsorption on rock surfaces. The one or more magnetic nanoparticles may include one or more stabilizing agents selected from a surface-active molecule, a short-chain polymer molecule or a combination thereof. The one or more magnetic nanoparticles may be nanospheres, nanorods, or their small aggregates, and more specifically may be iron-oxide nanospheres, nanorods, or their small aggregates. The one or more magnetic nanoparticles may include iron, cobalt, iron oxide, magnetite, hematite, ferrites, and combinations thereof. The one or more magnetic nanoparticles may have the formula XY₂O₄; wherein X and Y are metal atoms; and X, Y or both are Fe. The one or more magnetic nanoparticles may be in a cluster of 2-12 magnetic nanoparticles. The one or more magnetic nanoparticles may be 2-50 nm, 5-50 nm, 5-40 nm, 5-30, or 5-20 nm. The one or more magnetic nanoparticles are about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 nm. The method may further include the steps of moving the one or more magnetic nanoparticles through the subterranean formation. The first phase may be an aqueous phase, and the second phase may be a non-aqueous phase. The signal correlates to an internal structure of the subterranean formation. The subterranean formation may contain water, oil, gas, and combinations thereof. The detecting step may be conducted with at least one magnetic susceptibility meter, one magnetization detector such as SQUID, or a combination thereof.

The present invention provides a superparamagnetic nanoparticle ferrofluid for analyzing the movement of the injected fluid bank in a subterranean formation that includes one or more fluids; one or more superparamagnetic nanoparticles of less than 100 nm dispersed in the fluids; and a coating on the one or more superparamagnetic nanoparticles to ensure a long-term dispersion stability and to avoid adsorption on rock surfaces of the one or more superparamagnetic nanoparticles, wherein the one or more superparamagnetic nanoparticles are stable in the hydrocarbon phase. The one or more magnetic nanoparticles may further include one or more stabilizing agents selected from a surface-active molecule, a short-chain polymer molecule, or a combination thereof. The one or more superparamagnetic nanoparticles may include iron, cobalt, iron oxide, magnetite, hematite, ferrites, and combinations thereof. The one or more superparamagnetic nanoparticles may have a formula XY₂O₄, wherein X and Y are metal atoms, and X, Y or both are Fe. The one or more superparamagnetic nanoparticles may consist of iron-oxide. The one or more superparamagnetic nanoparticles may include a cluster of 2-12 magnetic nanoparticles. The one or more superparamagnetic nanoparticles may be 2-50 nm, 5-50 nm, 5-40 nm, 5-30, or 5-20 nm and more specifically, the one or more superparamagnetic nanoparticles may be about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 nm.

### DESCRIPTION OF THE DRAWINGS

For a more complete understanding of the features and advantages of the present invention, reference is now made to the detailed description of the invention along with the accompanying figures and in which:

FIG. 1 is an example plot of the magnetic susceptibility vs. nanoparticle concentration, as a function of the magnetic oscillation frequency, measured for a sample of the hydrophobic iron-oxide paramagnetic nanoparticles dispersed in decane.

FIG. 2 is an example plot of the magnetic susceptibility vs. measurement sample volume, as a function of the nanoparticle concentration, measured for a sample of the hydrophobic iron-oxide paramagnetic nanoparticles dispersed in decane.

FIG. 3 is an example plot of the magnetic susceptibility vs. nanoparticle concentration, as a function of the magnetic oscillation frequency, measured for a sample of the hydrophilic iron-oxide paramagnetic nanoparticles dispersed in de-ionized water.

FIGS. 4a-4e are the graphic description of the physical principles of MPI: a sinusoidal magnetic field H(t) (FIG. 4a) is applied to particles with a non-linear magnetization curve (FIG. 4b). The anharmonic magnetization (FIG. 4c) induces a signal u(t)∝dM(t)/dt in a receive coil (FIG. 4d). Due to the non-linear magnetization curve, the spectrum (FIG. 4e) of the acquired signal contains the excitation frequency f₀ as well as higher harmonics.

FIGS. 5a-5b are plots of sine current applied to the coil (5a); and sine magnetic field generated by the solenoid (5b).

FIGS. 6a-6b are plots of magnetization curves of nanoparticle at various sizes (6a); and excited magnetization of nanoparticle at various sizes (6b).

FIG. 7 is a plot of induced voltage signal generated by nanoparticle of various sizes and unit concentration.

FIG. 8 is a plot of total induced voltage signal generated by mixed nanoparticles.

FIG. 9 is a plot of Fourier spectrum of total induced voltage signal.

FIG. 10 is a plot of the size distribution of five types of nanoparticle of average diameter 15+/−5 nm, 20+/−5 nm, 25+/−5 nm, 30+/−5 nm, and 35+/−5 nm. The y-axis is the number density and the x-axis is the particle diameter (m).

FIGS. 11a-11f are plots of the spectrum planes produced by stepwise amplitude modulated exciting current. (FIG. 11a) 15±5 nm. (FIG. 11b) 20±5 nm. (FIG. 11c) 25±5 nm. (FIG. 11d) 30±5 nm. (FIG. 11e) 35±5 nm. (FIG. 11f) Recorded signal from simulation.

FIG. 12 is a schematic diagram of a surfactant micelle that has magnetic nanoparticles inside its hydrophobic core.

FIG. 13 is a schematic of the core setup during the core flood study. It shows the location of the pressure taps and pressure transducers across the core.

FIG. 14 shows the cumulative oil recovery, and oil cut (and remaining average oil saturation) of n-decane recovered from the surfactant-polymer flood of a sandpack with residual saturation in the core, after waterflood.

FIG. 15 is a plot of the nanoparticle concentration in the effluents.

FIG. 16 is a schematic of one embodiment of the apparatus for magnetic particle imaging.

### DESCRIPTION OF EMBODIMENTS

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Currently, to determine the oil saturation in-situ in the reservoir, a tracer which partitions between water and oil phases is injected with the injection water, and the amounts of the tracer in the produced water and oil are determined from chemical analysis, from which the oil saturation in the reservoir is deduced. With the proposed method, the amounts of the nanoparticles in the produced water and oil can be measured without contacting the fluids, which opens the possibility of an in-line, continuous measurements of those concentrations. To quantitatively identify the origin of the produced oil, a variety of paramagnetic nanoparticles which show different magnetization responses can be injected at different injection wells; and their respective effluent concentrations in the produced water and oil can be easily determined with the measurements of their magnetic susceptibility, magnetization responses to the applied magnetic fields, or a combination thereof.

The hydrophobic nanoparticles are prepared in such a way that they attach preferentially to a specific (“finger-printing”) component of the oil, such as H₂S, naphthenic acids, or asphaltenes. The different kinds of nanoparticles (injected at different injectors) produced with the oil can be collected employing the High-Gradient Magnetic Separation (HGMS) method; and the amount of the finger-printing component of the oil that is attached to each kind of nanoparticles can be determined. The origin (which flood pattern) of the finger-printing component can be accordingly determined. If the removal of the magnetic nanoparticles is required for subsequent refining of the oil, those can be removed by the HGMS method.

The present invention provides compositions with the ability to flow through porous environments. In general, the present compositions are of nanoscale size in at least one dimension and have a size between about 10 nm and about 1000 nm. The present compositions are operable to flow through small pores in a porous medium, e.g., soil, rock formations, and oil-containing geological formations, and are stable in aqueous solutions like brine, common in geological formations from which oil is produced.

Generally, the compositions of the present invention can be used for assaying fluid movement in a geological formation, by release downhole via injection, which are added to the injection water or brine and the compositions move through the geological formation. The compositions in the water, brine or oil produced from the production well are determined employing the current invention's characterization techniques. In instances when the assaying of the geological formation near the injection wellbore is desired, the flow may be reversed such that the compositions are then pulled back through the well and if desired can be analyzed by the current invention's characterization techniques. The present invention provides compositions and methods for assaying the fluid movement in a geological structure by dispersion of magnetic nanoparticles in a fluid; injecting the dispersion of magnetic nanoparticles into the geological structure; and detecting the magnetic response from the magnetic nanoparticles produced from the production well. In the present invention's embodiments, the geological structure is penetrated by a vertical well, a horizontal well, a hydraulic fracture, or combinations thereof.

The magnetic nanoparticles of the present invention include paramagnetic, superparamagnetic, and ferromagnetic materials. In various embodiments, the magnetic materials are dispersed in a fluid, e.g., water, brine, IOR injection fluid, drilling mud, fracturing fluid, and combinations thereof. Magnetic nanoparticles can be used during IOR flooding operations to monitor the progression, through the geological structure, of the IOR injection fluid and of the displaced oil bank. In addition, injection of the magnetic nanoparticles can also be conducted during fracturing, injected with proppants to monitor the extent of the fracturing process.

The present invention includes composition and methods for the dispersion of magnetic nanoparticles in an IOR fluid that is injected into the geological structures to displace oil in the geological structures. The magnetic nanoparticles may include iron, cobalt, iron oxide, magnetite, hematite, ferrites, and combinations thereof. As defined hereinabove, an illustrative iron oxide has a general chemical formula XY₂O₄, where X and Y are metal atoms with X and/or Y being Fe. In addition, the magnetic nanoparticles may be doped. The sizes of the injected magnetic materials are chosen to be most compatible with the selected magnetic probing application.

A typical example of the present invention's usage is summarized as follows: (1) Magnetic nanoparticles that have a hydrophobic surface coating are incorporated into the IOR surfactant formulation which is injected into an oil reservoir to displace the oil in it. In order to quantify the origin of the oil produced at a production well, magnetic nanoparticles of different magnetic properties are injected at different injection wells together with the IOR surfactant formulation. (2) When the surfactant micelles, which constitute the injection IOR formulation and which have the magnetic nanoparticles in their core, meet the resident oil to displace the oil, the hydrophobic nanoparticles are transferred from the surfactant micelles to the oil phase and move with the mobilized oil phase. The magnetic nanoparticles are then produced together with the oil at the production well. (3) When the mixture of different kinds of magnetic nanoparticles is produced, the IOR formulation injected into which injection well is responsible for how much of the produced oil, can be quantified by analyzing the composition of the produced magnetic nanoparticle mixture.

In the following section, the steps required to resolve the magnetic nanoparticle mixture composition are first described. The steps to incorporate the hydrophobic nanoparticles into the injection IOR surfactant formulation are then described.

Steps Required to Resolve the Magnetic Nanoparticle Mixture Composition:

When magnetic nanoparticles are dispersed in a liquid phase, their presence can be easily detected by measuring their magnetic susceptibility, χ. The magnetic susceptibility is the ratio of the magnetization (M) and the applied magnetic field (H):

$$χ ≡ \frac{M}{H} = \frac{{πφμ}_{o} {M}_{d}^{2} {d}^{3}}{18 kT} \qquad [ 1 ]$$

where φ is volume fraction of the nanoparticles; μₒ is vacuum permeability; M_{d} is bulk magnetization of the nanoparticle solid; d is nanoparticle diameter; and T is absolute temperature. The magnetic susceptibility can be measured with a susceptibility meter, which is usually done at a fixed frequency. Because χ in general increases monotonically with the volume fraction of magnetic nanoparticles in the mixture, it can be employed as a convenient way of measuring the particle concentration in the fluid, after developing a calibration curve that provides correlation between χ and concentration. Because the measurement can be made even when the particle-containing fluid is not transparent, the method is particularly advantageous to measure the concentration of tracer in crude oil. Because the measurement can be made and converted to the concentration value instantly, without involving any chemical analysis as with many conventional tracers, an in-line implementation of the invention to the oil production flow stream can be easily made.

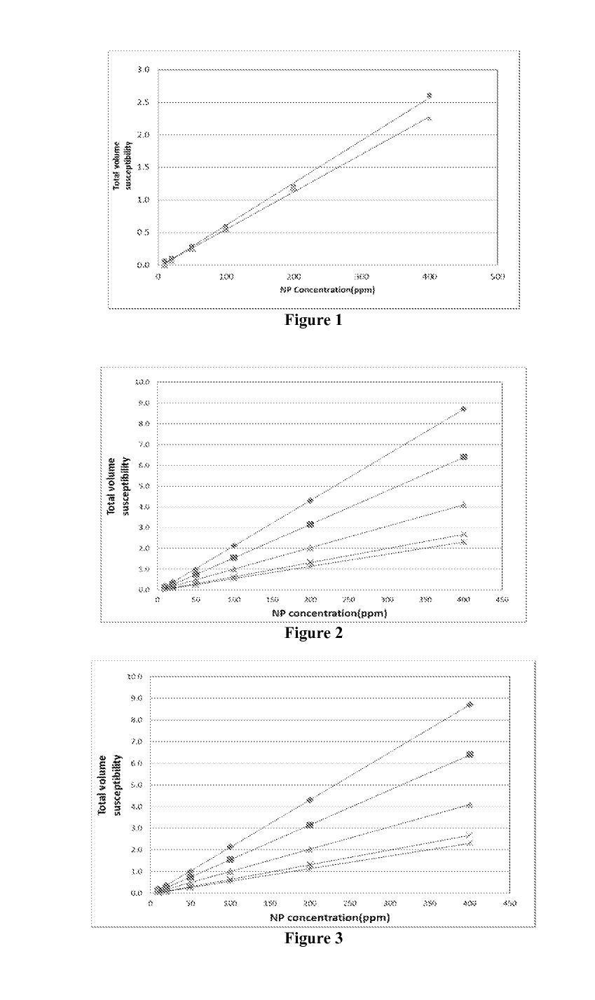

When only one kind of magnetic nanoparticles is used as a tracer, developing a calibration curve for χ vs. concentration at one fixed frequency suffices to determine the nanoparticle concentration in a fluid phase. FIG. 1 shows an example of the calibration curve, as a function of the magnetic oscillation frequency, measured with a sample of the hydrophobic iron-oxide nanoparticles dispersed in decane. The total mass magnetic susceptibility is linearly proportional not only to the nanoparticle concentration but also to the measurement sample volume. When the nanoparticle concentration is very dilute, therefore, the measurement volume can be increased to obtain better measurement accuracy. FIG. 2 shows an example of the total mass magnetic susceptibility vs. the sample volume, for different nanoparticle concentrations for the nanoparticles of FIG. 1. The measurement of the magnetic susceptibility can also be employed to determine the concentration of the hydrophilic magnetic nanoparticles that are dispersed in water or brine. FIG. 3 shows an example of the total mass magnetic susceptibility vs. the concentration of the hydrophilic iron-oxide nanoparticles dispersed in de-ionized water.

When two or more different kinds of magnetic nanoparticles are used as tracers, e.g., when different nanoparticles are injected at multiple injection wells, and are produced from a common production well, their individual concentrations need to be determined. For the purpose, the measurement of the magnetic susceptibility is not sufficient. In the present invention, a novel application of the magnetic particle imaging (MPI) technique is developed to determine the composition of a mixture of different kinds of the magnetic nanoparticles. Magnetic particle imaging (MPI) is a new tomographic imaging technique which measures the spatial distribution of superparamagnetic nanoparticles (Gleich & Weizenecker, 2005; Biederer et al., 2009). MPI is a quantitative imaging modality, providing high sensitivity and sub-millimetre spatial resolution. Furthermore, the acquisition time is short, allowing for real time applications. As the key feature of the MPI is the utilization of the non-linear magnetization responses by the magnetic nanoparticles, the principle of magnetization is first described here.

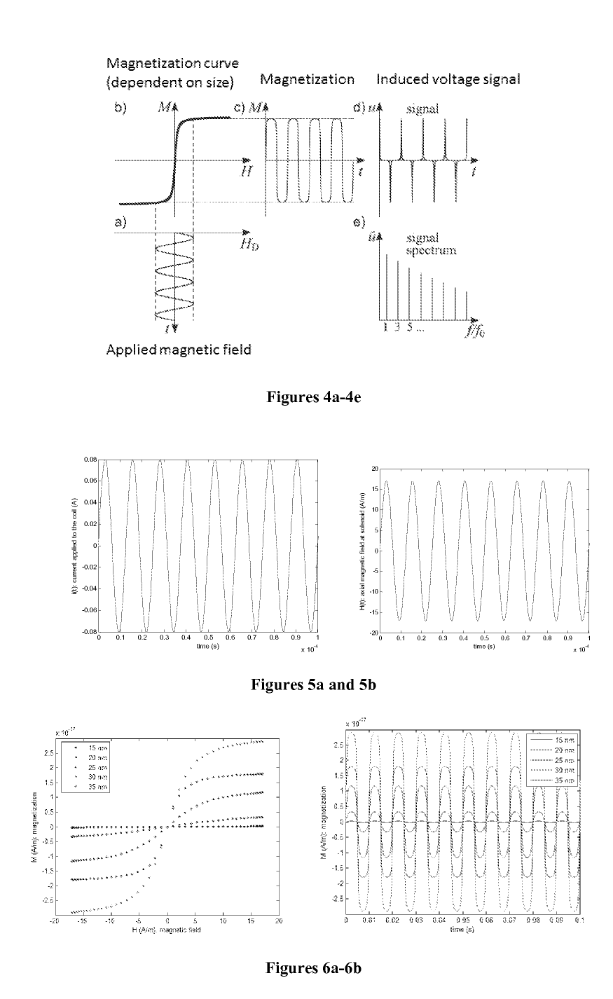

When a paramagnetic nanoparticle dispersion is subjected to a varying magnetic field strength (H), a unique magnetization response (M) results, which is known as the Langevin equation:

$$\frac{M}{{M}_{s}} = coth ( α ) - \frac{1}{α} ≡ L ( α ) \qquad [ 2 ]$$

where Mₛ=φM_{d} is the saturation magnetization of the dispersion with φ=volume fraction of nanoparticles and M_{d} is bulk magnetization of the nanoparticle solid. In Equation [2],

$$α ≡ \frac{{πμ}_{o} {M}_{d} {d}^{3} H}{6 kT} \qquad [ 3 ]$$

where μₒ=vacuum permeability; d=nanoparticle diameter; and T=absolute temperature. The parameters in Equations [2] and [3] are also defined with Equation [1] given above. As can be seen from the Langevin relation given above, it depends on the nanoparticle size and the bulk magnetization of the metal oxide that forms the nanoparticle core. As shown in FIG. 4b below, for superparamagnetic nanoparticles, the Langevin curve goes through the coordinate origin (H=0, M=0).

The fundamental principle of MPI is illustrated in FIGS. 4a-4e, which are from the paper by Biederer et al. (2009). To determine the spatial distribution of magnetic nanoparticles, a time varying magnetic field is applied to the nanoparticles (see FIG. 4a). Due to their non-linear magnetization curve (FIG. 4b), the magnetization response contains the excitation frequency f₀ as well as harmonics (i.e., integer multiples) of this frequency (FIG. 4c). In a receive coil, an electrical signal is induced, which is directly proportional to the time derivative of the particle magnetization (FIG. 4d). By Fourier transformation of the induced signal, the harmonics can be determined (FIG. 4e). The present inventors note that, while the MPI method as developed by Gleich and Weizenecker (2005) is to determine the spatial distribution of the magnetic nanoparticles, our novel application is to determine the composition of a mixture of different-size nanoparticles. The above steps will be described in more detail below.

When a sinusoidal current (with fixed frequency and fixed amplitude) is applied to a solenoid (FIG. 5a), the magnetic field generated by the solenoid is also sinusoidal (FIG. 5b). Using the law of Biot-Savart, the axial magnetic field near the center of a solenoid with length l, radius r and N windings is:

$$H ( t ) = \frac{N}{2 \sqrt{{( \frac{l}{2} )}^{2} + {r}^{2}}} i ( t ) \qquad [ 4 ]$$

where i(t) denotes the sine current applied to the coil. Our novel technique of distinguishing different nanoparticles magnetically is based on the fact that the magnetization curve is dependent on the size of nanoparticle, d, as shown above in Equation [3] and also in FIG. 6a. Different metal alloy oxides, which have different Langevin curve characteristics, can be also employed to expand the range of choice of different paramagnetic nanoparticles as tracers. For the basic model described in this section, we only consider monodisperse nanoparticles, i.e., nanoparticles having the same diameter. The magnetization response for different-size nanoparticles is shown as FIG. 6b.

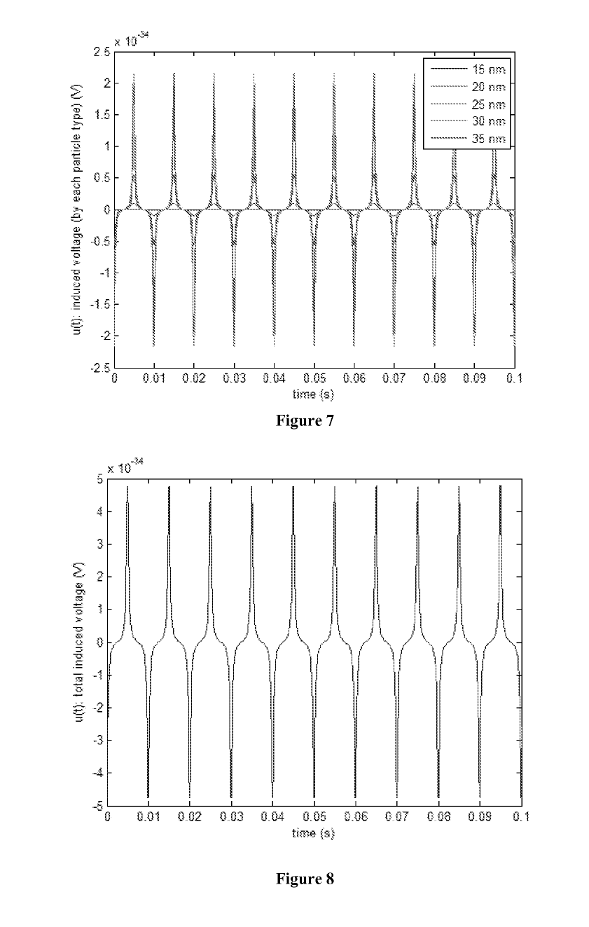

The temporal change in the particle magnetization M(t) induces a voltage u(t) in a receive coil, as shown in FIG. 7. It can be calculated using the reciprocity principle for magnetic recording:

$$u ( t ) = - {μ}_{o} {S}_{o} V \frac{d}{d t} M ( t ) \qquad [ 5 ]$$

where V is the sample volume, and Sₒ is coil sensitivity. From the amplitude of this induced voltage signal, the concentration of the nanoparticles in the solvent medium can be determined.

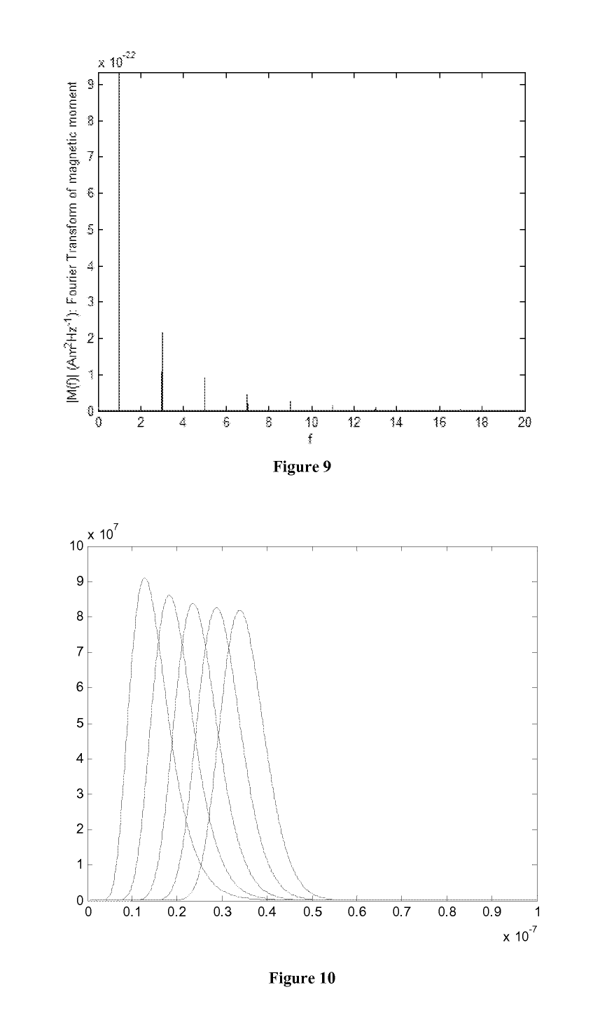

Composition Analysis from Paramagnetic Nanoparticle Mixture in Fluid: In this Section, the proposed method of determining the concentrations of different-size nanoparticles in a mixture, dispersed in a solvent medium such as a crude oil, is described. Because the concentrations of nanoparticles as tracers will be very small, we assume that the induced voltages from nanoparticle of each size are linearly additive. Under this assumption, the total voltage signal detected by the receiving coil is the weighted sum of individual signals generated by nanoparticle of each size, as shown in FIG. 8. The induced voltage signal is periodic with base frequency, fₒ. Due to the non-linearity of magnetization curve, the induced voltage signal contains the excitation frequency fₒ as well as harmonics (i.e., integer multiples) of fₒ, as shown in FIG. 9. The spectrum is discrete for a periodic signal: Mₖ=M(fₖ)=M(kfₒ) where M is the continuous spectrum. Based on the linear mixture model, the spectrum of the total induced signal is the linear combination of spectrum of individual nanoparticle size. Assuming there are totally P types of nanoparticles with different size, and the spectrum contains K spikes, non-negative linear least square fitting is used to estimate the individual concentration of nanoparticle for each overall mixture concentration.

The result of a natural growth process during particle synthesis does not yield particles with a single diameter d, but with a polydisperse particle size distribution. The theoretical estimation of the magnetic response from paramagnetic nanoparticles with a given size distribution has been studied by Chantrell et al. (1978) and others. A reasonable and commonly used approach for modelling is the log-normal distribution. The probability density function ρ(d) is given by:

$$\begin{matrix}ρ ( d ) = \frac{1}{\sqrt{2 π} d σ} exp [ - \frac{1}{2} {( \frac{𝓁 n ( d ) - μ}{σ} )}^{2} ] d \geq 0 \\ = 0 d < 0\end{matrix} \qquad [ 6 ]$$

where parameter μ and σ are calculated from the expectation E(X) and standard deviation \sqrt{Var(X)}. An example of the size distribution is shown below in FIG. 10. With the size distribution, the total induced signal will be the sum of all components weighted by the distribution probability density.

The estimation of concentration of each nanoparticle component is dependent on the nonlinearity of magnetization curve at each particle size. Since the magnetization curve has various nonlinearities at different magnetic field, it is possible to further separate the nanoparticle component by replacing the exciting magnetic field with an amplitude modulated magnetic field. With amplitude modulation, the magnetization response spectrum contains multiple spikes. As a result, the amplitude modulation introduces more usable data for concentration estimate and potentially produces more accurate estimation. An effective way to modulate the amplitude of the exciting current is to discretely change the amplitude of the sine current stepwise and simultaneously record the spectrum of the recorded signal. In this approach, we introduced another dimension (exciting amplitude) to the original 1D recorded spectrum. As a result, magnetic nanoparticles of each size (or size mixture) produce a signature spectrum surface in the frequency domain when excited with stepwise amplitude modulated exciting current. FIG. 11(a-e) shows examples of the signature spectrum surface produced by nanoparticles with 5 different average sizes, each with the size distribution as given by FIG. 10. FIG. 11(f) shows the spectrum surface of the recorded signal of an unknown mixture composed of the 5 types of magnetic nanoparticles. Ideally, it is basically a mixture of the spectrum surfaces in FIG. 11(a-e) weighted by their concentration, plus noise. The concentration of each nanoparticle size can be estimated by applying the least-square inversion model.

An inversion computer program which calculates the composition of the nanoparticle mixture from the measured signal as described above has been developed. The initial “blind” tests with hypothetical mixtures with 5 different-size nanoparticles provide excellent predictions of the composition. We also tested the inversion algorithm when each particle size has a certain size distribution; and the initial prediction of the mixture composition is reasonably good. In order to demonstrate the accuracy of the estimation of magnetic nanoparticle concentrations, the results of a series of blind tests are given below. In the series of tests, 20 test cases were randomly generated. In each test case, there are 5 types of magnetic nanoparticle in the mixture (diameter distribution centered at 15, 20, 25, 30, and 35 nm with the log-normal size distribution). The concentration of each nanoparticle component was random in each test case. The effective detected signal is then calculated by summing up the signals generated by each component and noise, excited with the exciting current. The inversion model was subsequently applied to the simulated detected signal to estimate the concentration of each nanoparticle component. The averaged error rate was then calculated for each nanoparticle component by averaging the error rate of the concentration estimation among the 20 test cases. The results are listed in Table 1.

TABLE 1
Mixture Composition Prediction from Inversion Model

| | Particle diameter | | | | |
|---|---|---|---|---|---|
| | 15 nm | 20 nm | 25 nm | 30 nm | 35 nm |
| Average | 51.4141 | 20.6851 | 9.0036 | 2.9203 | 0.4861 |
| error (%) | | | | | |

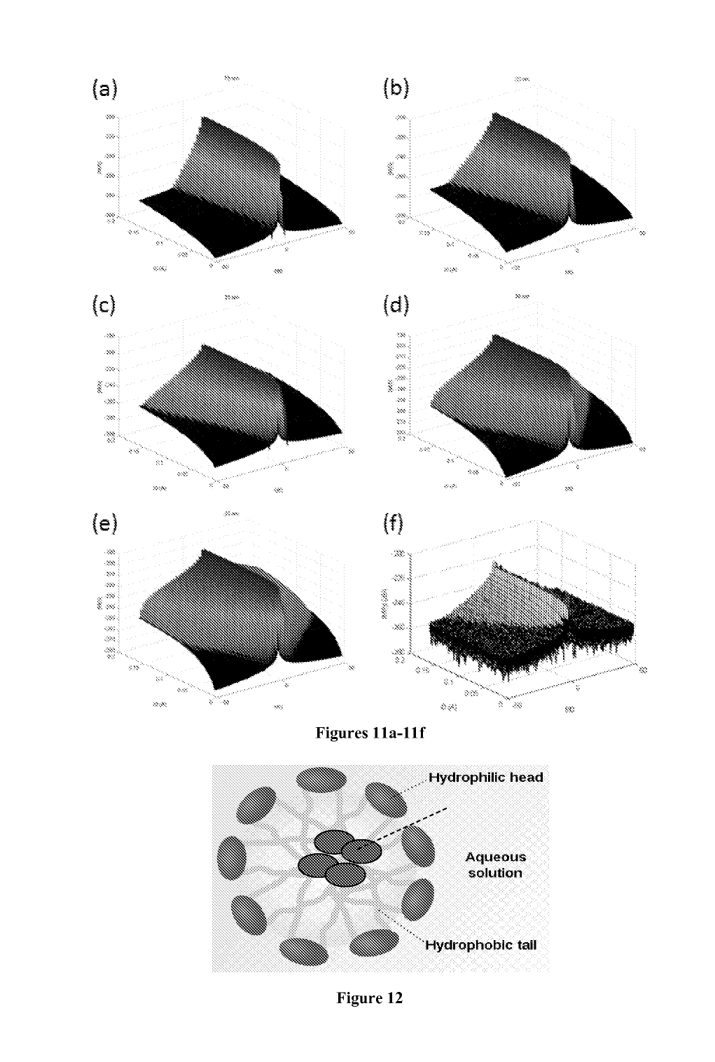

Incorporation of the Hydrophobic Magnetic Nanoparticles into the Injection Fluid for In-Reservoir Transfer to the Oil Phase: A typical example of the present invention's usage is to include the magnetic nanoparticles inside of the surfactant micelles that are a constituent of the injection formulation prepared for the surfactant-polymer enhanced oil recovery (EOR) process. A schematic diagram of a surfactant micelle that has magnetic nanoparticles inside its hydrophobic core is shown in FIG. 12. As the injection EOR formulation that carries the magnetic nanoparticles contacts the oil resident in the oil reservoir and displaces it, the nanoparticles are spontaneously transferred to the oil phase because of their hydrophobic surface coating. The nanoparticles now dispersed in the newly mobilized oil are then produced at the production well together with the oil. Because the oil mobilized by the injection EOR formulation is in general produced much earlier than the surfactant from the injection formulation, the effectiveness of the EOR formulation in mobilizing the reservoir oil can be judged at a fairly early stage of the EOR project operation.

The transport of the Fe₃O₄ nanoparticles during an EOR process, according to the present invention is illustrated with a laboratory surfactant-polymer flood which was carried out with a sandpack at waterflood residual oil saturation. This sandpack core flood demonstrated the feasibility of delivering the magnetic nanoparticles to the oil phase in the sandpack, incorporated in the injected surfactant formulation. The injection surfactant formulation was developed through phase behavior experiments using n-decane (C10), which is also the resident oil in the sandpack. From the phase behavior studies, the formulation using 0.32 wt % Petrostep-S-2, 0.98 wt % Petrostep-S13D, and 1.95 wt % IBA showed sufficient solubilization ratio and aqueous stability. The optimal salinity is about 3.75 wt % NaCl. The properties of the sandpack and the flood conditions are given in Table 2 below. The sandpack was first water flooded with 5.0 wt % NaCl brine to reach the residual oil saturation state. The flood was carried out at room temperature (23° C.) and atmospheric pressure, with injection at a frontal velocity of 1 ft/day.

In addition to the above surfactants and IBA, the injection formulation also included 1200 ppm of Flopaam 3630S polymer to produce viscosity of ˜14.0 cp (at shear rate of 1 s⁻¹). Its salinity was 3.75 wt % NaCl. It also included ˜420 ppm iron oxide nanoparticles (Fe₃O₄) with hydrophobic coating (FerroTec Lot 1300) and 0.25 wt % of pentadecane. The nanoparticles were incorporated into the injection formulation in the following way: 17 wt % of iron oxide nanoparticles was first dissolved in pentadecane (C15), which was used to help dissolve more nanoparticles in the surfactant formulation. Without the hydrocarbon addition, a sufficient amount of nanoparticles could not be dispersed in the surfactant formulation. When decane was used for nanoparticle incorporation, a microemulsion phase distinct from the injection formulation phase was formed, which was not ideal for injection. Thus, pentadecane was used to “dissolve” the nanoparticles because the optimum salinity for C15 was higher than C10's optimum salinity, thus creating oil-in-water microemulsion (Type I) at the 3.75 wt % salinity, which is compatible with the injection formulation. Approximately 0.3 wt % of the nanoparticle dispersion in C15 was thus added to the injection formulation; and the nanoparticle-containing surfactant slug was filtered using 1.2 μm filter to remove any non-dispersed nanoparticles. The filtration ratio of the slug was ˜1.0, indicating an excellent filterability of the nanoparticle-containing injection formulation.

For the nanoparticle transport and delivery test, the sandpack was prepared by slowly pouring in sand while vibrating the core holder to produce a homogeneous close-packed sandpack. The two pressure taps were added at the inlet and the outlet to measure the pressure drop along the core. The sandpack was saturated with 2.0 wt % NaCl and the brine permeability was calculated from the pressure drop measurement. A tracer test was run using 5.0 wt % NaCl to calculate the pore volume of the sandpack. Decane was injected at 20 ml/min until the residual water saturation was reached. The core was then waterflooded with 5.0 wt % NaCl brine at 1.36 ml/min until the residual oil saturation was reached. Continuous injection of the nanoparticle-containing surfactant formulation was then injected at 0.14 mL/min at 23° C. The effluent samples from the oil displacement core flood were collected for later analysis for the concentration of the nanoparticles in the effluent stream. The core data is shown in Table 2 below.

TABLE 2
Nano-C10-03PV Core Properties

| Core | Nano-C10-03PV | |
|---|---|---|
| Rock type | Sandpack | |
| Length | 22.23 | cm |
| Diameter | 1.89 | inch |
| Porosity | 0.36 | |
| Permeability | 3100 | md |
| Temperature | 23 | ° C. |
| Pore Volume | 144.7 | mL |

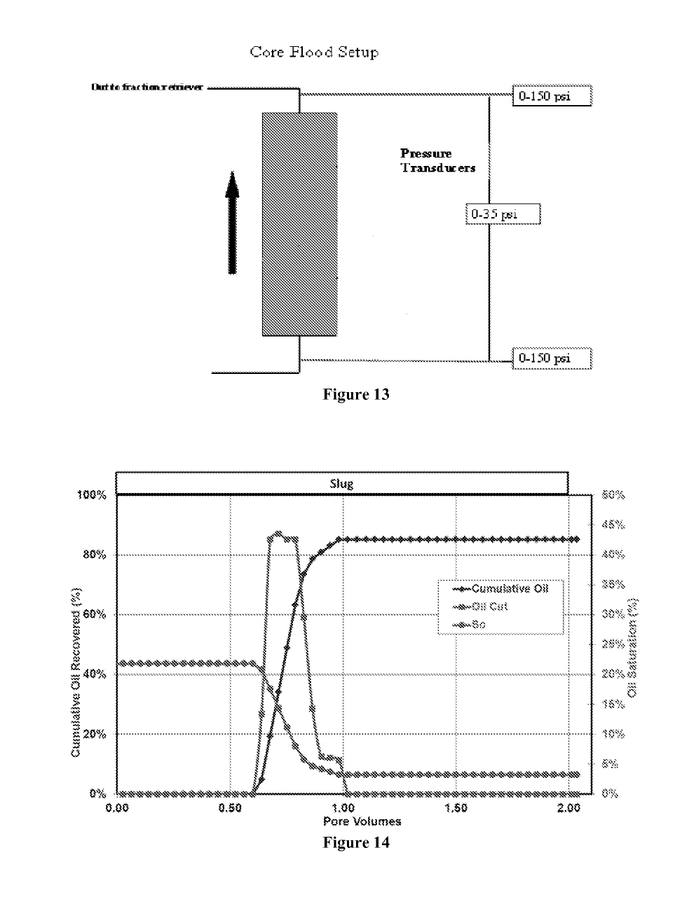

FIG. 13 is a schematic of the core setup for the core flood study. It shows the location of the pressure taps and pressure transducers across the core. The core was flooded with decane (viscosity=0.85 cP) that had been filtered through a 0.45 micron nitro-cellulose filter at 50 psi and 25° C. The oil flood was conducted at a constant flow rate of 20 mL/min. The permeability measured at the end of the oil flood is 1400 mD, which provides the oil relative permeability end point of 0.452. The oil saturation (Sₒᵢ) upon completion of the oil flood was 0.713. The core was then flooded with 5.0 wt % NaCl brine at a flow rate of 1.36 mL/min (or 9.87 ft/day) close to the residual oil saturation state. The residual oil saturation (S_{orw}) was 0.218, and the final waterflood permeability was 660 mD, which provides the brine relative permeability end point value of 0.217.

A continuous injection of the nanoparticle-containing surfactant formulation was made at a flow rate of 0.14 mL/min (˜1 ft/day) at 23° C. Effluent samples were collected in graduated tubes every 40 minutes with a sample size of ˜5.6 mL. The final oil recovery was ˜85% of the oil left after waterflood, which comes out to be the remaining oil saturation of S_{orc}=0.032. There was a significant amount of Type III microemulsion in some of the collected effluent samples. In the calculation of the oil recovery and S_{orc}, the small amount of oil in the microemulsion was not included. If the oil in microemulsion was included in the calculation of final oil recovery, it would be around 90-95%. FIG. 14 shows the cumulative oil recovery and oil cut (and average oil saturation left in the core) from the surfactant-polymer flood of a sandpack which had the residual n-decane saturation after waterflood.

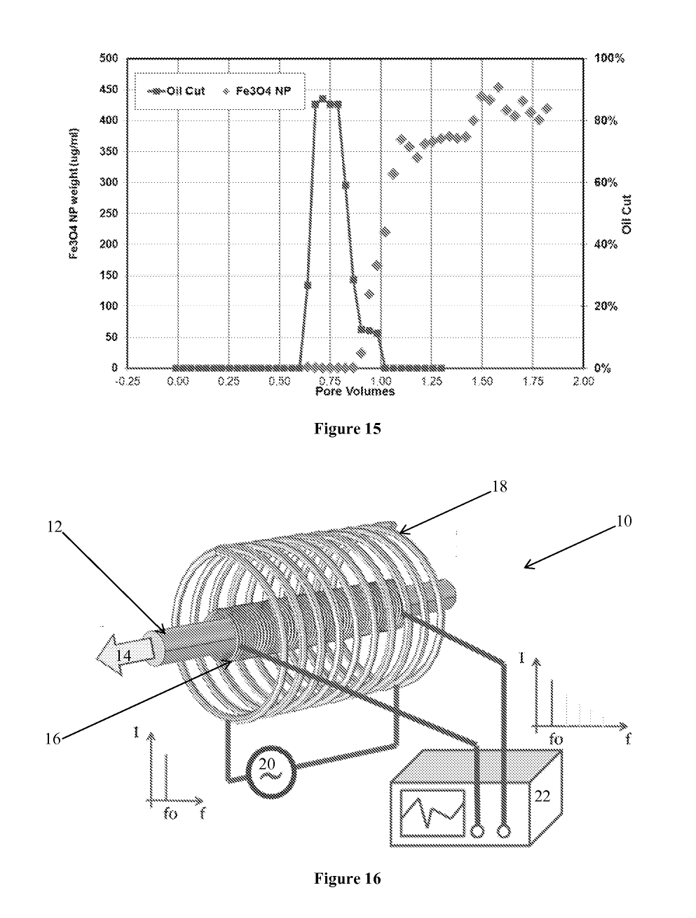

FIG. 15 is a plot of the nanoparticle concentration in the effluents vs. the injected pore volume, together with the oil cut plot. As judged from the brownish color of the oil bank formed and displaced by the injection surfactant formulation, traces of the nanoparticles were produced almost from the front end of the oil bank; and the measurable concentrations of the nanoparticles were observed at the rear portion of the oil bank, as shown in the plot. It demonstrated that a part of the injected nanoparticles were successfully transferred to the mobilized oil bank and produced with it.

FIG. 16 is a schematic of one embodiment of the apparatus for magnetic particle imaging. The apparatus for magnetic particle imaging 10 includes a magnetically translucent pipe 12 to carry the flow 14 of the magnetic nanoparticles (not shown) in the oil (not shown). The magnetically translucent pipe 12 is surrounded by a first set of coils 16 which is then surrounded by a second set of coils 18. An AC current source is attached to the second set of coils 18 and a detector is connected to the first set of coils 16.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

What is claimed is:

1. A method of tracking and quantifying oil mobilized by an injection surfactant formulation injected for enhanced oil recovery comprising the steps of:
providing one or more magnetic nanoparticles comprising a specific surface coating that can be incorporated into the injection surfactant formulation at a desired amount;
providing one or more magnetic nanoparticles comprising a specific surface coating that can be readily transferred when they contact an oil resident in a subsurface formation;
incorporating the one or more magnetic nanoparticles into the injection surfactant formulation to form a nanoparticle-containing surfactant formulation for injection into an injection well for enhanced oil recovery;
injecting the nanoparticle-containing surfactant formulation into the subsurface formulation, wherein the one or more magnetic nanoparticles are transferred to a mobilized oil and an oil left in the reservoir;
recovering the oil produced at the production well;
measuring a magnetic susceptibility of the production well oil;
determining a magnetic nanoparticle concentration of the one or more magnetic nanoparticles in the production well oil; and
quantifying the amount of the mobilized oil out of the oil resident before the injection of the surfactant formulation.

2. The method of claim 1, wherein a first magnetic nanoparticle is injected at a first injection well and a second magnetic nanoparticle is injected at a second injection well and a first magnetic nanoparticle concentration and a second magnetic nanoparticle concentration are determined from the oil produced from a production well, from the measurements of the magnetic susceptibility, the non-linear magnetization response to the applied magnetic oscillation, or the combination thereof.

3. The method of claim 2, wherein the relative amounts of oil produced from the two different injection well patterns are quantified from the analysis of the concentrations of the two different nanoparticles.

4. The method of claim 1, wherein more than two different kinds of nanoparticles are injected at more than two different injection wells; and their individual concentrations are determined from the oil produced from a production well, from the measurements of the magnetic susceptibility, the non-linear magnetization response to the applied magnetic oscillation, or the combination thereof.

5. The method of claim 4, wherein the relative amounts of oil produced from the more than two different injection well patterns are quantified from the analysis of the concentrations of the more than two different nanoparticles.

6. The method of claim 1, wherein the one or more magnetic nanoparticles comprise iron, cobalt, iron (III) oxide, magnetite, hematite, ferrites, and combinations thereof.

7. The method of claim 1, wherein the one or more magnetic nanoparticles have a formula XY₂O₄, wherein X and Y are metal atoms, and X, Y or both are Fe.

8. The method of claim 1, wherein the one or more magnetic nanoparticles comprise a cluster of 2-12 magnetic nanoparticles.

9. The method of claim 1, wherein the one or more magnetic nanoparticles are 2-50 nm, 5-50 nm, 5-40 nm, 5-30, or 5-20 nm.

10. The method of claim 1, wherein the one or more magnetic nanoparticles are about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 nm.

11. The method of claim 1, further comprising the steps of moving the one or more magnetic nanoparticles through the subterranean formation.

12. The method of claim 1, wherein the magnetic susceptibility and the non-linear magnetization response signals measured from the produced oil correlates to an internal structure of the subterranean formation.

13. The method of claim 1, wherein the detecting step is conducted with at least one magnetic susceptibility meter.

14. A magnetic, paramagnetic, or superparamagnetic nanoparticle ferrofluid for analyzing the efficiency of oil displacement by an enhanced oil recovery fluid in a subterranean formation comprising:
an enhanced oil recovery fluid;
one or more magnetic, paramagnetic, or superparamagnetic nanoparticles of less than 100 nm incorporated in the fluid; and
a surface coating on the one or more nanoparticles to ensure their easy incorporation into the surfactant formulation in the enhanced oil recovery fluid, and their ready transfer to the resident oil when they contact the oil phase.

15. The ferrofluid of claim 14, wherein the one or more magnetic, paramagnetic, or superparamagnetic nanoparticles further comprise one or more coating agents selected from a surface-active molecule, a polymeric molecule, or a combination thereof.

16. The ferrofluid of claim 14, wherein the one or more magnetic, paramagnetic, or superparamagnetic nanoparticles comprise iron, cobalt, iron (III) oxide, magnetite, hematite, ferrites, and combinations thereof.

17. The ferrofluid of claim 14, wherein the one or more magnetic, paramagnetic, or superparamagnetic nanoparticles have a formula XY₂O₄, wherein X and Y are metal atoms, and X, Y or both are Fe.

18. The ferrofluid of claim 14, wherein the one or more magnetic, paramagnetic, or superparamagnetic nanoparticles comprise a cluster of 2-12 magnetic nanoparticles.

19. The ferrofluid of claim 14, wherein the one or more magnetic, paramagnetic, or superparamagnetic nanoparticles are 2-50 nm, 5-50 nm, 5-40 nm, 5-30, or 5-20 nm.

20. The ferrofluid of claim 14, wherein the one or more magnetic, paramagnetic, or superparamagnetic nanoparticles are about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 nm.
